(19) United States
(12) Patent Application Publication
(10) Pub. No.: US 2002/0097222 A1
(43) Pub. Date: Jul. 25, 2002

(54) Computer system with optical pointing device

(76) Inventor: Masaaki Nishino, Tokyo (JP)

Correspondence Address: McGinn & Gibb, PLLC, Suite 200, 8321 Old Courthouse Road, Vienna, VA, 22182-3817, US

(21) Appl. No.: 10/053,739

(22) Filed: Jan. 24, 2002

(30) Foreign Application Priority Data
Jan. 25, 2001 (JP) 017394/2001

(51) Int. Cl. G09G 5/08

(52) U.S. Cl. 345/157

(57) ABSTRACT

A computer system for facilitating an operation of a pointing device and reducing power consumption thereof. The computer system is implemented with a display screen, a pointing device, and a position detecting unit. The pointing device includes a position indicating button thereon. The pointing device emits a beam of light in response to a push of the position indicating button. The position detecting unit detects a position at which the beam reaches on the display screen.

### BACKGROUND OF THE INVENTION

1. Field of the Invention

The present invention is related to a computer system. More particularly, the present invention is related to a computer system with a pointing device that emits a beam of light to indicate a position on a display screen.

2. Description of the Related Art

A pointing device is used for indicating a position on a display screen. A mouse, a roller boll control system, a tablet, and a touch sensitive display screen are typical pointing devices.

Recently, wireless optical pointing devices have been proposed for remotely indicating a position on a display screen. Motoyama discloses a wireless optical pointing device in Japanese Open Laid Patent Application (Jp-A-Heisei 11-24842). The conventional pointing device is provided with a semiconductor laser diode, an electromagnetic wave generator, and electromagnetic wave sensors that are placed at the periphery of a display screen. The semiconductor laser diode emits a laser beam to indicate a position on the display screen. The position on the display screen is detected based on the outputs of the electromagnetic wave sensors.

Yoshida discloses another wireless optical pointing device in Japanese Open Laid Patent Application (Jp-A-Heisei 8-331667). The wireless pointing device is implemented with a light emitting device, a video camera, a position determining unit, and an antenna. The light emitting device emits a beam of light to indicate a position on a display screen. The video camera obtains an image of the display screen. The position determining unit determines the indicated position on the basis of the image. A position indicating signal representative of the position is transmitted to a computer system through the antenna.

Sano et al. disclose still another wireless optical pointing device in Japanese Open Laid Patent Application (Jp-A-Heisei 9-179685). The pointing device is provided with a light emitting indicator and an optical signal detector. The light emitting indicator is composed of buttons, an LED (Light Emitting Diode), an oscillator, and an LED driver. The oscillator oscillates in a frequency in response to ON/OFF states of the buttons. The LED driver drives the LED so as to emit optical pulse signal while the pulse frequency thereof is adjusted to the frequency of the oscillator. The optical signal detector is composed of a position detector detecting the position indicated by the optical pulse signal, and a frequency detector detecting the pulse frequency. Position information representative of the indicated position and ON/OFF information representative of the ON/OFF states of the buttons of the light emitting indicator are transmitted to a computer system.

### SUMMARY OF THE INVENTION

Therefore, an object of the present invention is to provide a computer system with a pointing device for reducing power consumption of the pointing device.

Another object of the present invention is to provide a computer system with a pointing device for facilitate an operation of the pointing device.

Still another object of the present invention is to provide a computer system with a pointing device for avoiding a wrong operation of the computer system caused by a wrong.

Yet still another object of the present invention is to provide a computer system with a pointing device for simplifying the configuration thereof.

In order to achieve an aspect of the present invention, a computer system is implemented with a display screen, a pointing device, and a position detecting unit. The pointing device includes a position indicating button thereon. The pointing device emits a beam of light in response to a push of the position indicating button. The position detecting unit detects a position at which the beam reaches on the display screen.

The pointing device preferably emits the beam only when the position indicating button is pushed.

When the display screen includes an LCD (Liquid Crystal Display), the position detecting unit preferably detects the position based on a transmitting portion of the beam transmitting through the LCD.

In this case, the position detecting unit preferably includes a plurality of photodetectors arranged in rows and columns, each of which outputs a beam detection signal in response to the portion of the beam, and a processing unit determining the position in response to the beam detection signals.

It is also preferable that the position detecting unit detects the position based on a scattered portion of the beam being scattered by the display screen.

In this case, the position detecting unit preferably includes a plurality of first photodetectors arranged in a row at a first edge of the display screen, and a plurality of second photodetectors arranged in a column at a second edge of the display screen.

The detection of the position on the basis of the scattered portion of the beam is especially effective when the display screen is a CRT (Cathode Ray Tube) display.

The pointing device may include an LED (Light Emitting Diode) that emits the beam, and may include a laser that emits the beam.

When the computer system is implemented with a processing unit that displays a cursor on the display screen, the processing unit preferably moves the cursor to the detected position when the position indicating button is pushed.

In this case, it is preferable that the pointing device outputs a cursor movement signal in response to the push of the position indicating button, and that the processing unit moves the cursor to the position in response to the cursor movement signal.

The cursor movement signal is preferably transmitted through a cable connected to the pointing device.

When the processing unit displays a figure on the display screen, it is preferable that the pointing device further includes a click button thereon, and the figure is selectable by a click of the click button when the figure is pointed by the cursor.

In this case, it is preferable that the pointing device outputs a click signal in response to the click of the click button, and the processing unit causes the figure to be selected in response to the click signal, and the cursor movement signal and the click signal are transmitted through a cable connected to the pointing device.

In order to achieve another aspect of the present invention, a pointing device system is implemented with a pointing device and a position detecting unit. The pointing device includes a position indicating button thereon. The position indicating button allows the pointing device to emit a beam of light in response to a push of the position indicating button. The position detecting unit detecting a position at which the beam reached on a display screen.

In order to achieve still another aspect of the present invention, a method of operating a computer system is comprised of:

emitting a beam of light in response to a push of a position indicating button provided for a pointing device; and

detecting a position at which the beam reaches on a display screen.

In order to achieve yet still another aspect of the present invention, a method for indicating a position on a display screen is composed of:

providing a pointing device including a position indicating button thereon;

pushing the position indicating button to allow the pointing device to emit a beam of light to indicating the position on the display screen.

### BRIEF DESCRIPTION OF THE DRAWINGS

FIG. 1 shows a computer system according to the present invention in a first embodiment;

FIG. 2 shows a block diagram of the computer system;

FIG. 3 shows a position detecting unit of the computer system in the first embodiment;

FIG. 4 shows a position detecting unit of the computer system in a second embodiment;

FIG. 5 shows the position detecting unit in a second embodiment; and

FIG. 6 shows the arrangement of the position detecting unit in the second embodiment.

### DESCRIPTION OF THE PREFERRED EMBODIMENTS

A computer system according to the present invention will be described below in detail with reference to the attached drawings.

### First Embodiment

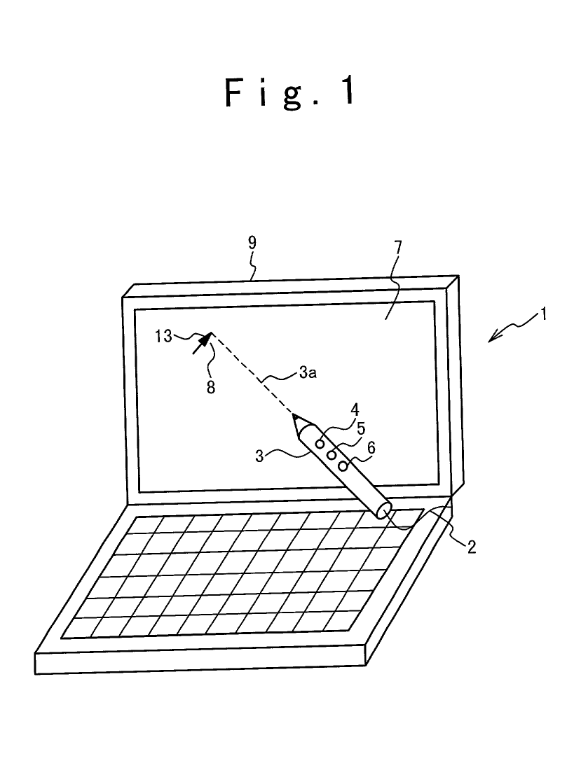

In a first embodiment, a computer 1 is provided with a pen-type pointing device 3, as shown in FIG. 1. The pointing device 3 is connected to the computer 1 with a cable 2. The computer 1 includes an LCD 7 as a display screen therein.

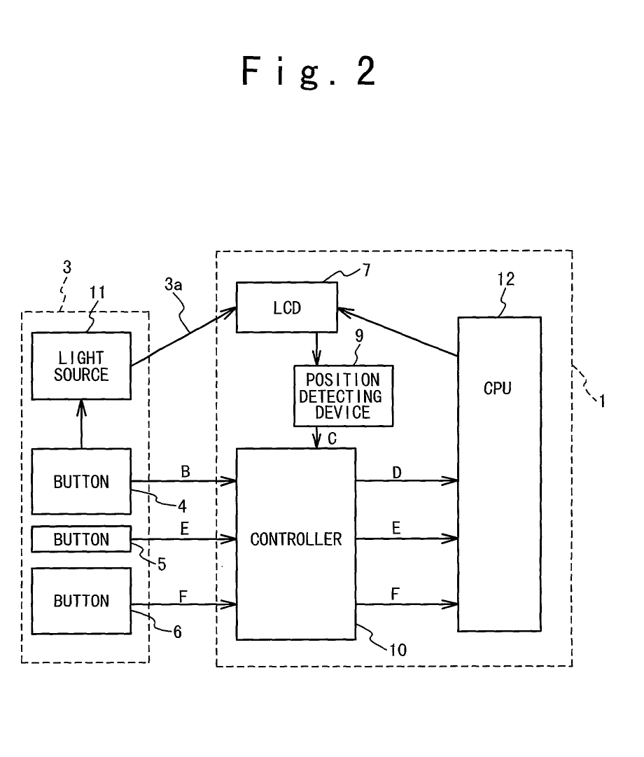

The pointing device 3 is provided with a position indicating button 4 thereon. The position indicating button 4 allows the pointing device 3 to emit a beam of light when the position indicating button 4 is pushed or pressed. The beam of light is denoted by the beam 3a, hereinafter. As shown in FIG. 2, the beam 3a is generated by a light source 11, such as LED (Light Emitting Diode) and a laser diode. As shown in FIG. 1, the beam 3a indicates a position 8 where the beam 3a reaches on the LCD 7.

As shown in FIG. 2, the position indicating button 4 also allows the pointing device 3 to generate a position detection allowing signal B when the position indicating button 4 is pushed. The position detection allowing signal B is transmitted through the cable 2 to the computer 1.

As shown in FIG. 1, the pointing device 3 is also provided with click buttons 5 and 6 thereon. As shown in FIG. 2, the pointing device 3 generates button operation signals E and F respectively in response to clicks of the click buttons 5 and 6. The button operation signals E and F are transmitted through the cable 2 to the computer 1.

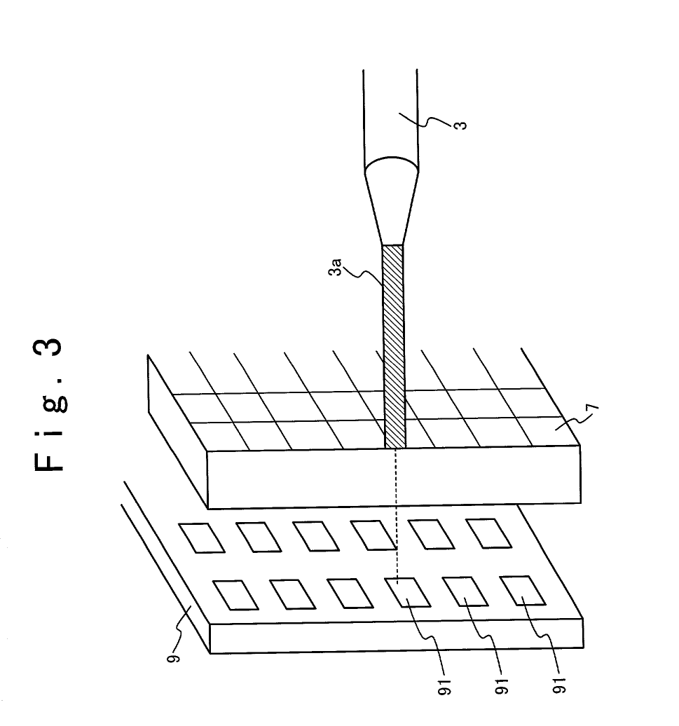

The computer 1 includes a position detecting device 9, a controller 10, and a CPU (Central Processing Unit) 12 as well as the LCD 7. As shown in FIG. 3, the position detecting device 9 is located behind the LCD 7. The position detecting device 9 is composed of photodetectors 91 arranged in rows and columns. The beam 3a partially transmits through the LCD 7 to one(s) of the photodetectors 91. Each of the photodetectors 91 outputs a beam detection signal C in response to the intensity of the transmitting portion of the beam 3a.

The controller 10 receives the beam detection signals C from the photodetectors 91 and determines the position 8 indicated by the beam 3a on the LCD 7. When the controller 10 recognizes that the position indicating button 4 is pushed on the basis of the position detection allowing signal B, the controller 10 determines the position 8 on the basis of the beam detection signals C from the photodetectors 91. The controller 10 generates a position indicating signal D representative of the coordinates of the position 8 to output to the CPU 12. The controller 10 also transfers the button operation signals E and F from the pointing device 3 to the CPU 12.

As shown in FIG. 1, the CPU 12 displays on the LCD 7 a cursor 13 and other figures, such as icons, windows and a pull down menu (not shown). When the position indicating button 4 is pushed or pressed, the CPU 12 moves the cursor 13 to the indicated position 8 in response to the position indicating signal D.

The CPU 12 allows the displayed figures to be selectable in response to a click of the click button 5. The CPU 12 recognizes the click of the click buttons 5 with reference to the button operation signal E from the pointing device 3. While a not-selected figure is pointed by the cursor 13 on the LCD 7, the CPU 12 causes the not-selected figure to be selected and set at a selected state in response to a click of the click button 5. While a selected figure is pointed by the cursor 13 on the LCD 7, on the other hand, the CPU 12 causes the selected figure to be not selected and set at a not-selected state in response to a click of the click button 5. That is, the click of the click button 5 functions as a “left-click” of a conventional mouse.

Furthermore, the CPU 12 operates a predetermined task when the click button 6 is clicked. The CPU 12 recognizes the click of the click button 6 with the button operation signal F from the pointing device 3. For example, the CPU 12 displays a pull down menu in a window on the LCD 7 when the click button 6 is clicked. That is, the click of the click button 6 functions as a “right-click” of a conventional mouse.

The operation of the computer system will be described below.

When the position indicating button 4 is pushed, the pointing device 3 emits the beam 3a at the LCD 7. The emission of the beam 3a is selectively executed only when the position indicating button 4 is pushed. The selective emission of the beam 3a reduces the power consumption of the pointing device 3.

The position detecting device 9 receives the transmitting portion of the beam 3a through the LCD 7 and generates the beam detection signals C.

In the meantime, the pointing device 3 generates the position detection allowing signal B in response to the push of the position indicating button 4.

The controller 10, in response to the position detection allowing signal B, determines the position 8 indicated by the beam 3a on the LCD 7, on the basis of the beam detection signals C. The controller 10 outputs the position indicating signal D representative of the position 8.

The CPU 12 moves the cursor 13 to the indicated position 8 in response to the position indicating signal D.

While the position indicating button 4 is not pressed, on the other hand, the cursor 13 is fixed.

When the click button 5 is clicked, the CPU 12 causes a figure pointed by the cursor 13 to be set to the selected state or the not-selected state in response to the button operation signal E. When not selected before the click of the click button 5, the pointed figure becomes selected and set at the selected state. When selected before the click, the point figure becomes unselected and set at the not-selected state.

When the click button 6 is clicked, the CPU 12 executes a predetermined task in response to the button operation signal F.

The fixation of the cursor 13 by not-pressing the position indicating button 4 avoids wrong operations of the computer 1 when the click buttons 5 and 6 are clicked. While the position indicating button 4 is not pressed, the beam 3a is not emitted from the pointing device 3, and the detection of the position 8 is not executed. Thus, the cursor 13 is fixed while the position indicating button 4 is not pressed. If the cursor 13 is not fixed, the reaction of the click of the click buttons 5 and 6 may cause a flutter of the cursor 13, and thus cause a wrong operation of the computer 1. The cursor 13, however, is fixed while the position indicating button 4 is not pressed, and thus the wrong operations of the computer 1 are avoided.

### Second Embodiment

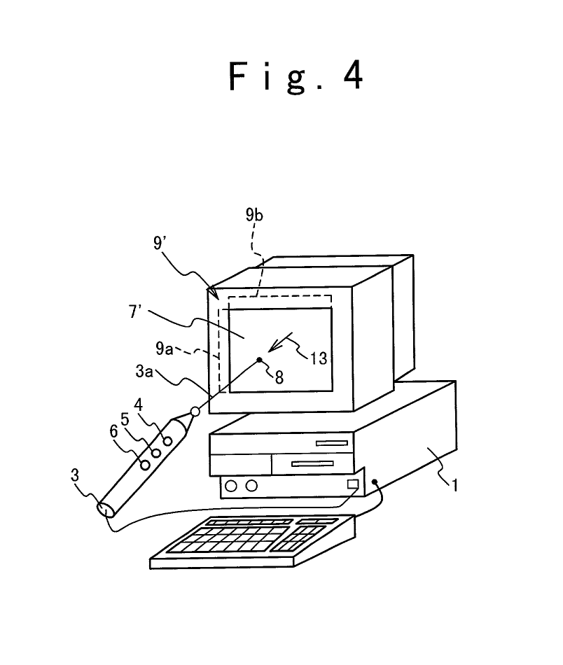

In a second embodiment, the present invention is adapted to a desktop computer system as shown in FIG. 4. The desktop computer system in the second embodiment has the same configuration as the computer system in the first embodiment except for that the LCD 7 is replaced by a CRT display 7′, and that the position detecting device 9 is replaced by a position detecting device 9′ which detects a scattered portion of the beam 3a which is scattered on the surface of the CRT display 7′.

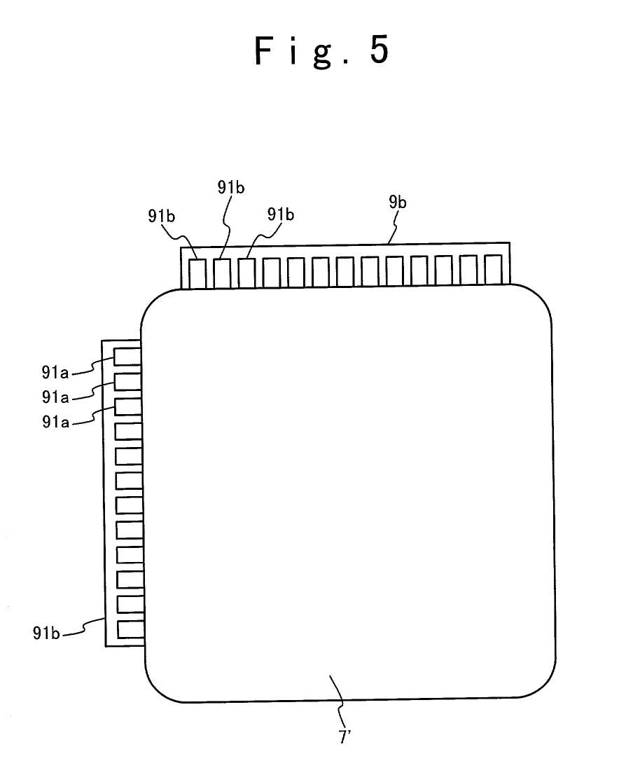

As shown in FIG. 5, the position detecting device 9′ includes a vertical photodetector array 9a and a horizontal photodetector array 9b. The vertical photodetector array 9a is located at a vertical edge of the CRT display 7′ and the horizontal photodetector array 9b is located at a horizontal edge of the CRT display 7′. The vertical photodetector array 9a includes photodetectors 91a arranged in a column, while the horizontal photodetector array 9b includes photodetectors 91b arranged in a row, which is substantially perpendicular to the column.

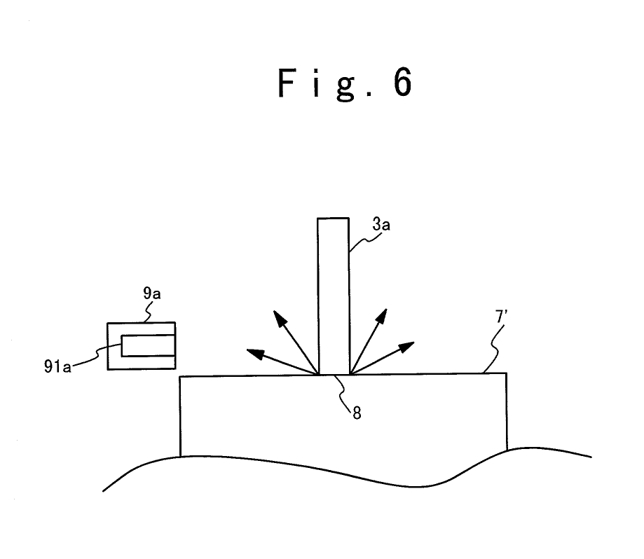

As shown in FIG. 6, each of the photodetectors 91a and 91b detects the scattered portion of the beams 3a, and generates the beam detection signal C in response to the intensity of the scattered portion of the beam 3a. The beam detection signal C, which is generated on the basis of the scattered portion of the beam 3a, is used for the determination of the position 8 indicated by the beam 3a.

Other operations of the desktop computer system are identical to those of the computer system in the first embodiment.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

What is claimed is:

1. A computer system comprising:
a display screen;
a pointing device including a position indicating button thereon, wherein said pointing device emits a beam of light in response to a push of said position indicating button; and
a position detecting unit detecting a position where said beam reaches on said display screen.

2. The computer system according to claim 1, wherein said pointing device emits said beam only when said position indicating button is pushed.

3. The computer system according to claim 1, wherein said display screen includes an LCD (Liquid Crystal Display), and
wherein said position detecting unit detects said position based on a transmitting portion of said beam transmitting through said LCD.

4. The computer system according to claim 3, wherein said position detecting unit includes:
a plurality of photodetectors arranged in rows and columns, each of which outputs a beam detection signal in response to said transmitting portion of said beam, and
a processing unit determining said position in response to said beam detection signals.

5. The computer system according to claim 1, wherein said position detecting unit detects said position based on a scattered portion of said beam being scattered by said display screen.

6. The computer system according to claim 5, wherein said position detecting unit includes:
a plurality of first photodetectors arranged in a row at a first edge of said display screen, and
a plurality of second photodetectors arranged in a column at a second edge of said display screen.

7. The computer system according to claim 6, wherein said display screen is a CRT (Cathode Ray Tube) display.

8. The computer system according to claim 1, wherein said pointing device includes an LED (Light Emitting Diode) that emits said beam.

9. The computer system according to claim 1, wherein said pointing device includes a laser that emits said beam.

10. The computer system according to claim 1, further comprising a processing unit displaying a cursor on said display screen,
wherein said processing unit moves said cursor to said position when said position indicating button is pushed.

11. The computer system according to claim 10, wherein said pointing device outputs a position indication allowing signal in response to said push of said position indicating button, and
wherein said processing unit moves said cursor to said position in response to said position indication allowing signal.

12. The computer system according to claim 11, further comprising a cable connected to said pointing device, wherein said position indication allowing signal is transmitted through said cable.

13. The computer system according to claim 11, wherein said processing unit displays a figure on said display screen, and
wherein said pointing device further includes a click button thereon, and
wherein said figure is selectable by a click of said click button when said figure is pointed by said cursor.

14. The computer system according to claim 13, further comprising a cable connected to said pointing device, wherein said pointing device outputs a click signal in response to said click of said click button, and
wherein said processing unit causes said figure to be selected in response to said click signal, and
wherein said position indication allowing signal and said click signal are transmitted through said cable.

15. A pointing device system comprising:
a pointing device including a position indicating button thereon, wherein said position indicating button allows said pointing device to emit a beam of light in response to a push of said position indicating button; and
a position detecting unit detecting a position at which said beam reached on a display screen.

16. A method of operating a computer system, said method comprising:
emitting a beam of light in response to a push of a position indicating button provided for a pointing device; and
detecting a position at which said beam reaches on a display screen.

17. The method according to claim 16, wherein said beam is emitted only when said position indicating button is pushed.

18. The method according to claim 16, wherein said display screen includes an LCD (Liquid Crystal Display), and
wherein said position is detected based on a transmitting portion of said beam transmitting through said LCD.

19. The method according to claim 16, wherein said position is detected based on a scattered portion of said beam being scattered by said display screen.

20. The method according to claim 16, further comprising:
displaying a cursor on said display screen; and
moving said cursor to said position when said position indicating button is pushed.

21. The method according to claim 20, further comprising:
displaying a figure on said display screen, and
selecting said figure in response to a click of a click button provided for said pointing device.

22. A method for indicating a position on a display screen, said method comprising:
providing a pointing device including a position indicating button thereon;
pushing said position indicating button to allow said pointing device to emit a beam of light to indicating said position on said display screen.
